(19) United States
(12) Patent Application Publication
(10) Pub. No.: US 2010/0225721 A1
(43) Pub. Date: Sep. 9, 2010

(54) TABLE HAVING INDICIA ON SURFACE

(75) Inventors: William Martin Crabtree, Sedalia, MO (US); Martin Lee Crabtree, Sedalia, MO (US)

Correspondence Address: Pearne & Gordon LLP, 1801 East 9th Street, Suite 1200, Cleveland, OH, 44114-3108, US

(73) Assignee: ABC ADVERTISING AGENCY, INC., Sedalia, MO (US)

(21) Appl. No.: 12/717,227

(22) Filed: Mar. 4, 2010

Related U.S. Application Data
(60) Provisional application No. 61/157,602, filed on Mar. 5, 2009.

(51) Int. Cl. B41J 2/01

(52) U.S. Cl. 347/102

(57) ABSTRACT

A method of creating a display on a table top having an upper surface is provided. The method comprises the steps of printing indicia on the upper surface of the table top and curing the indicia to create the display. The method further includes the steps of applying a first sealant layer over at least a portion of the display on the upper surface, and curing the first sealant layer. In one example, at least one of the ink and the first sealant layer is curable via exposure to a radiation source. In another example, the radiation source is a source of ultraviolet light.

### CROSS-REFERENCE TO RELATED APPLICATIONS

This application claims the benefit of U.S. Provisional Application No. 61/157,602, filed Mar. 5, 2009, the entire disclosure of which is hereby incorporated herein by reference.

### FIELD OF THE INVENTION

The present invention relates to table top displays for displaying information on table tops, and more specifically, to an improved method of creating such table top displays.

### BACKGROUND OF THE INVENTION

Table tops having indicia, such as advertisements, drawings, photos, and/or words thereon, are commonly used in restaurants and other retail establishments. Conventional table displays typically include numerous small advertisements, photos, or drawings arranged on the table top. These small displays must be individually created and then arranged on and adhered to the table top. These steps are time consuming and therefore limit the number of table top displays that can be efficiently created.

Conventional table top displays also include sealant coatings placed over the designs to protect the designs from liquids placed on the table tops. Unfortunately the sealant coatings, which are typically made of epoxy, often damage the displays.

Moreover, the sealant coatings on prior art table top displays often cover the entire upper surface of the table top and extend over and wrap around a portion of the side edges of the tables. Although this effectively seals the entire upper surface and side edges of the tables from liquids placed on the table, the sealant coatings can become chipped or cracked when chairs or other objects are pushed up against the sides of the tables.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a method of creating a display on a table top having an upper surface is provided. The method comprises the steps of printing indicia on the upper surface of the table top using a radiation curable ink, and curing the printed indicia using a radiation source to create the display. The method further comprises the steps of applying a first sealant layer over at least a portion of the display on the upper surface, and curing the first sealant layer.

In accordance with another aspect of the present invention, a method of creating a display on a table top having an upper surface is provided. The method comprises the steps of printing indicia on the upper surface of the table top, and curing the printed indicia to create the display. The method further comprises the steps of applying a first sealant layer using a radiation curable material over at least a portion of the display on the upper surface, and curing the first sealant layer using a radiation source.

In accordance with another aspect of the present invention, a method of creating a display on a table top having an upper surface is provided. The method comprises the steps of printing indicia on the upper surface of the table top using a radiation curable ink, and curing the printed indicia using a first radiation source to create the display. The method further comprises the steps of applying a first sealant layer using a radiation curable material over at least a portion of the display on the upper surface, and curing the first sealant layer using a second radiation source.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a top view of a table top display constructed in accordance with an aspect of the subject application;

FIG. 2 is a fragmented side-sectional view of the table top display depicting example layers on the upper surface of the table top; and

FIG. 3 is a schematic view of an example method of manufacture of the table top display.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

The drawing figures illustrate a table top display 10 constructed in accordance with the subject application. The table top display 10 broadly includes a table top 12, a surface 14 having a display 16 (e.g., advertisements, drawings, photos, images, and/or words, etc.) printed thereon, and a sealant coating 18 (e.g., sealant layer) covering at least a portion of the table top. The thicknesses of the individual layers on top of the table top 12 are exaggerated for clarity.

Table top 12 can be a conventional restaurant table top, which may be attached to conventional supportive legs or the like. Table top 12 presents the generally flat upper surface 14, and may be made of metal, plastic, glass, wood, fiberglass, formica, stone, or other similar materials. The table top 12 can include various geometries having various sizes. For example, a relatively smaller table top 12 can include a 24-inch square table, while a relatively larger table top 12 can include a 60-inch round table. It is to be understood that the phrase “table top” can include surfaces that are not traditional table tops. For example, the subject application can be utilized with relatively long surfaces, such as a sign or relatively long counter or bar-top for holding items and/or serving customers. In one example, a relatively long counter could be about 10-feet long and 60-inches wide. The various apparatus and methods discussed herein may include elements with physical constraints, such as a printer or coater having a predetermined operational minimum/maximum length, width, and/or depth, etc. Of course, various sizes and geometries are contemplated.

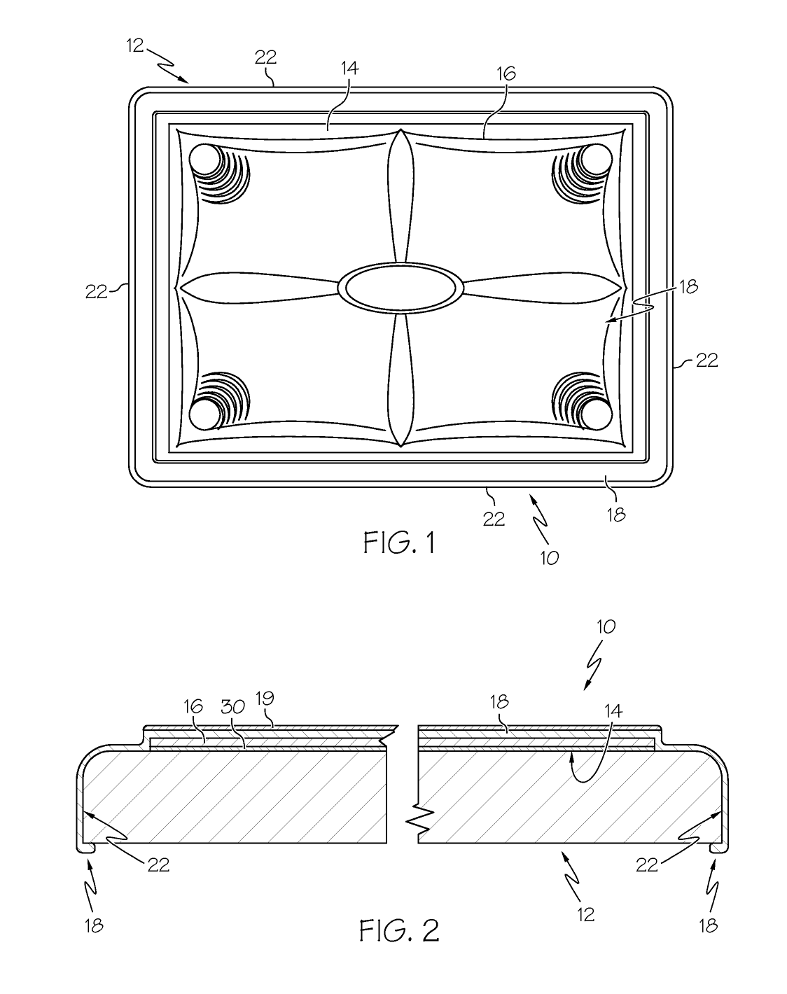

For clarity, the apparatus and methods will be discussed with reference to an example table top display 10, though it is to be understood that such discussion can similarly apply to various other items. As shown in FIGS. 1-2, the example table top 12 is generally square or rectangular and has four side edges 22 extending downwardly from the outer margins of the upper surface 14. It is understood that the upper surface 14 may or may not be the uppermost surface. The methods of the subject application may be performed on new table tops as they are manufactured or may be performed on existing table tops in use in restaurants or other retail establishments. Exiting table tops may require various additional steps to prepare the table top for processing (e.g., printing and/or coating, etc.).

The upper surface 14 may be of any size generally equal or less than the surface area of the table top. In one example, the upper surface 14 can be sized so that it extends to within ¼″-½″ of the side margins (e.g., side edges 22) of the table top 12 to permit the display 16 to cover substantially the entire surface area of the upper surface of the table top 12. Still, the upper surface 14 and/or display(s) 16 can be recessed away from the edges by various amounts. In other examples, the displays 16 can be placed variously about the upper surface 14, arranged in various patterns, arrays, or even randomly, and/or in various groupings or even separately.

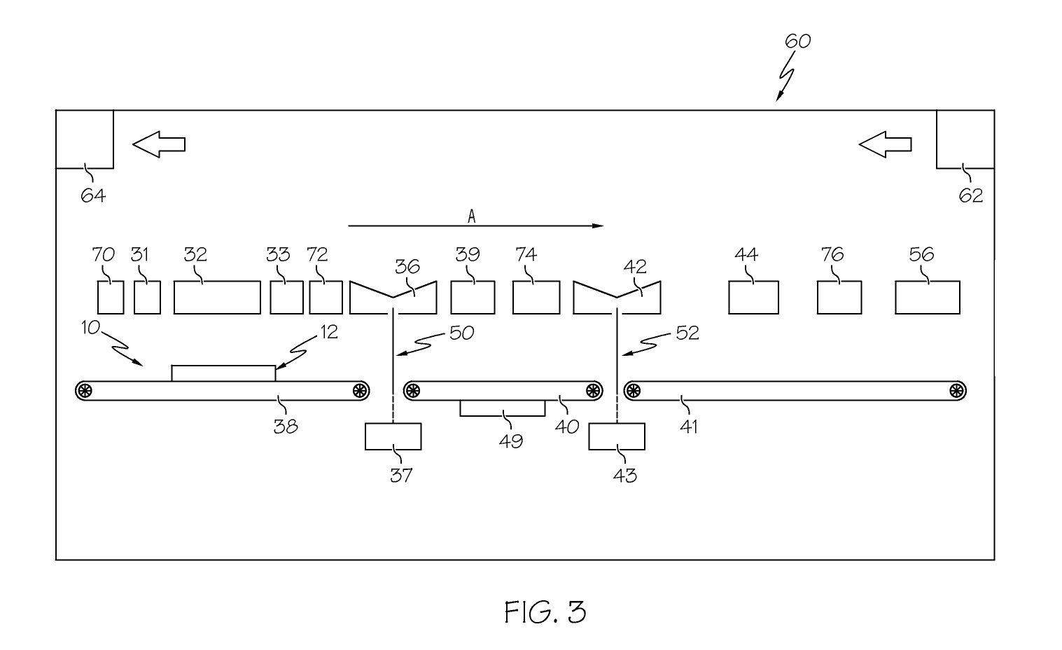

Next, the method of the instant application can include the step of printing indicia on the upper surface 14 of the table top 12 to create the display 16. It is understood that the step of printing the indicia on the upper surface 14 includes printing directly upon upper surface 14, or indirectly upon the upper surface 14 via printing onto a coating layer. For example, the upper surface 14 of the table top 12 can have a printable surface, and/or be prepared with a base-coat surface 30 (e.g., a coating layer) that is printable, such as a white coated surface. The base-coat surface 30 may be of any size generally equal or less than the surface area of the upper surface 14. The upper surface 14 can be pre-coated, such as prepared wood, fiberglass, formica, or the like. In another example, as shown schematically in one example process flow of FIG. 3, methods of the instant application can include the step of applying the base-coat surface 30. Application of the base-coat surface 30 can be manually or automatically performed in various manners, such as using an automatic or manual applicator 31. In one example, the base-coat surface 30 can be an exterior or interior latex paint or the like, though various other paints or the like can also be used. The base-coat surface 30 can have various colors (or can even be clear). In one example, the color white can be desirable as it is relatively easy to print upon and provides for good print colors. Still, various other colors may also be used to provide various other print colors or effects. Alternatively, a clear base-coat layer 30 may be preferred if it is desired for the wood grain or other texture of the table top upper surface 14 to show or be visible through the printed indicia as hereafter described. In addition or alternatively, a plurality of base-coat surfaces 30 can be applied, each being applied at least partially, such as completely, over the entire upper surface 14. In one example, a plurality of base-coat surfaces 30 can be applied upon each other.

Next, the method of the instant application can include the step of placing the table top 12 onto a flat bed printer 32 for printing the indicia to create the advertising display(s) 16 upon the table top 12. The printer 32 can be a separate machine, or even part of a larger machine/apparatus. For example, the display(s) 16 can be printed upon the base-coat surface 30 and/or directly upon the upper surface 14. The display(s) may be selected as a matter of design choice. The display(s) can include custom displays and/or stock displays, and can be provided by various sources. In one example, the display(s) can be a custom display provided by a customer, such as digitally via a portable storage medium or through a network (e.g., the Internet). The display(s) 16 can be printed using various printers, such as various flat bed printers available from Mimaki Co. The flat bed printer can include a relatively large print area, such as about ten feet long by about six feet wide, though various sizes and geometries are contemplated. In another example, the printer 32 may be limited by one dimension only, and generally unlimited in another dimension. For example, the printable area of the printer 32 can be limited by a predefined printable width, but may be generally unlimited in printable length, such as where the table top 12 is movable relative to the printer 32. It is understood that either or both of the printer 32 and table top 12 can be movable relative to the other. For example, the printer 32 can be operatively connected to a conveyor system 38 or the like. In another example, the printer 32 can have a movable print head or the like.

Next, printed indicia can be curing the using a radiation source to create the display. The flat bed printer 32 can utilize various inks having various colors, thicknesses, etc. In one example, the flat bed printer 32 can utilize a radiation cured ink that is curable by exposure to a radiation source, such as a UV-curable ink that utilizes ultraviolet (UV) light to dry the printed ink quickly by exposing the printed ink to said UV light. The UV-cured ink can provide increased resistance to damage from rubbing, heat, bleeding, etc. In one example, the printer 32 can utilize one or more UV lamps to enable high speed, multi-directional printing. In addition or alternatively, a UV-curing oven 33, such as an oven provided by Dubois Equipment Co., can be provided downstream of the printer 32 to cure the ink. In addition or alternatively, the flat bed printer 32 can include a vacuumed table that holds the table top 12 flat and relatively stationary during the printing process. In another example, the table top 12 can be movable relative to the printer 32 during the printing process. Still, it is to be understood that traditional air-drying, heat-drying, or other types of inks an also be used.

Once the display 16 is printed on the table top 12, the method can include the step of applying at least one sealant layer 18 (see FIG. 2) over at least a portion of the table top 12. The sealant layer 18 can inhibit blurring or bleeding of the images or designs, and/or otherwise protect the printed display(s) 16 from damage. In one example, the sealant layer 18 can be applied so that it covers substantially all of the upper surface 14 of the table top 12 without extending over the side edges 22 of the table top. As discussed above, this can inhibit the sealant layer 18 from chipping or cracking when chairs or other objects are pushed up against the side edges 22 of the table top 12, as is discussed in U.S. Pat. No. 5,861,075, which is incorporated herein by reference. In another example, as shown, the sealant layer 18 can be applied so that it covers substantially all of the upper surface 14 of the table top 12 while also extending over some or all of the side edges 22 of the table top. This can provide a relatively more complete protection of the table and the printed displays 16. Relatively stronger materials can be utilized for the sealant layers 18 to inhibit chipping and cracking when chairs or other objects are pushed up against the side edges 22 of the table top 12.

The sealant layer 18 can include various materials, such as a clear acrylic material, epoxy, or other natural or synthetic coating. While the sealant layer 18 may be relatively clear, it can also include various colors and/or other effects, such a glitter or other decorative elements. Various example sealant materials can include Gemini HG Clear UV coatings, such as UV-1131 or UV-1128, in gloss, satin, or other styles. The sealant layer 18 can be applied in various conventional manners. In one example, the coating material can be a radiation cured material that is curable by exposure to a radiation source, such as a UV-curable material, that is applied uniformly in a curtain coating process. In one example curtain coating process, a curtain coater 36 includes a bath with a slot in the base to allow a generally continuous curtain 50 of the sealant layer 18 coating to fall by gravity, forming an unsupported liquid sheet or curtain. The curtain 50 falls into a gap, such as a gap in one conveyor or even between two adjacent conveyors 38, 40. A collecting trough 37 is located generally below the gap to catch excess, un-used sealant, which can be filtered and pumped back to the coater 36 for re-use, or can be discarded. In addition or alternatively, the curtain coating process can be conveyor-driven. In one example, the table top 12 to be coated is passed along the conveyor 38, 40 at a controlled speed and through the liquid curtain 50 to receive the sealant layer 18 coating on its upper surface 14. The controlled speed may be static or variable to provide a desired sealant layer 18 coating.

Various UV-curable acrylic materials can be used, such as from Gemini Co. Other coatings can include UV-curable urethanes, lacquers, epoxies, or the like. Various coating thicknesses can be used, such as about 0.010-0.015 inches or the like. In addition or alternatively, the curtain coater 36 can provide a generally fixed width curtain 50, such as about 64″ wide, or can even provide an adjustable width curtain 50. For example, the width of the curtain 50 can be adjustable, such as reduced to between 36″-48″, which can be beneficial to reduce waste and/or reduce the pumped volumetric flow of sealant to the curtain coater 36 bath to thereby improve process efficiency.

The radiation-cured sealant layer 18 provides a smooth, level surface and may further reduce, such as eliminate, the need for additional surface treatments of the table top 12. Still, additional surface treatments may still be used, as discussed herein. Applying the sealant layer 18 can eliminate small surface defects, such as pinholes or fine scratches on the table top 12. It is also understood that various other layers can also be used.

Next, the method can include the step of curing the sealant layer 18. For example, the table top 12 can be placed into a UV-curing oven 39, such as an oven provided by Dubois Equipment Co. The UV-curing oven 39 can include one or more UV sources for curing the sealant layer 18 in a relatively quick manner. The UV-curing oven 39 may or may not include heat sources and/or cooling sources to provide even and quick curing of the sealant layer 18. The total cure time can be relatively quick, such as less than about 5 minutes, or even less than about 2 minutes. The UV-curing oven 39 can utilize various configurations of UV-sources, such as sources located relatively above, below, and/or to the side of the table top 12 for adequately curing the entire the sealant layer 18. While the term “oven” is used herein, it is understood that heat may or may not be used in the curing process.

Where a table includes more than four sides (or has a curved side surface), more than two curtain coating processes can be used. In addition or alternatively, multiple curtain coaters can be used to provide multiple sealant layers 18, 19 to provide a relatively thicker protective layer, and/or achieve a desired surface finish quality. For example, the various sealant layers 18, 19 can utilize different materials and/or can provide various finishes, such as a satin finish, a high gloss finish, or other desired surface finish. In other examples, one sealant layer 18 can be relatively thicker, while another sealant layer 19 can be relatively thinner, or vice versa. The second sealant layer 19 can be applied over at least a portion, such as all, of the first sealant layer 18.

In addition or alternatively, the curtain coating process can adequately coat all four of the side edges of the table top 12. However, the two side edges 22 that pass directly through the curtain of liquid may be coated differently than the other side edges. For example, the other two opposed sides may or may not be adequately coated. Thus, the table top 12 can be rotated manually or automatically approximately 90 degrees (or other desired angle) and passed through a second curtain coater 42 (or even the same coater 36) so as to coat the two opposed sides. An additional conveyor 40 can be used, and can include a turn table 49 or the like for orienting the table top 12. In another example, the additional conveyor 40 can be oriented at an angle relative to the upstream conveyor 38, such as at a 90-degree “L” shape, such that the table top 12 is re-oriented via movement of the table top 12 from the first conveyor 38 to the next conveyor 40. The second curtain coater 42 can be similar to the first curtain coater 36 to provide a generally continuous curtain 52 of the second sealant layer 19. The second curtain coater 42 can also include an additional collecting trough 43, etc., or can even share elements with the first coater 36, such as a common collecting trough (not shown). Still, in another example, the second sealant layer 19 may not coat any of the side edges.

Next, the method can include the step of curing the second sealant layer 19, such as in a second UV-curing oven 44 (similar to the first oven 39) or even using the first UV-curing oven 39 again. While two curing ovens 39, 44 are illustrated, it is understood that more or less ovens can be used. In one example, the table top 12 can be provided with multiple sealant layers 18, 19 and only a single curing process that is performed only after all of the sealant layers 18, 19 have been applied (e.g., no intermediate curing).

Next, the method can include the step of collecting the finished table tops 12 from the output of the UV-curing oven 44 on a conveyor 41 or the like, and stacking or otherwise preparing the products for storage or shipment at an end station 56. The finished table tops 12 can be automatically or manually stacked and/or prepared for storage or shipment using a drop table, packager, or the like.

In addition or alternatively, any or all of the curtain coater(s) 36, 42 can be replaced or supplemented by other coaters. In one example, a spray coating process can be used to apply the sealant layer(s) 18, 19. For example, the second sealant layer 19 can be applied using a spray coater (manual or automatic, not shown) that can apply a relatively thin spray coat on top of some or all of the first sealant layer 18.

In addition or alternatively, one or more surface adjustment processes, such as sanding and/or polishing steps, can be applied to the table top display 10 during the various processes described herein. The surface adjustment processes can be applied directly to the table top or indirectly to any coating/layer thereupon. For example, the sanding or polishing can prepare the table top 12 (or any layers thereon) to receive a coating, and/or make the table top display 10 more attractive. The one or more sanding or polishing steps can be applied to some or all of the surface area of the table top 12 (or any layers thereon). In one example, the table top 12 can be sanded or polished at stage 70 prior to either or both of the applicator 31 and printer 32. The sanding or polishing can prepare the table top 12 to receive the base-coat surface 30, and/or prepare the table top 12 and/or base-coat surface 30 to be printed upon. In addition or alternatively, the table top 12 can be sanded or polished at stage 72 prior to receiving the first coating layer 18 via coater 36, and/or at stage 74 (e.g., after the first coating 18) prior to receiving the second coating layer 19 via coater 42. In addition or alternatively, the table top 12 can be sanded or polished (e.g., buffed) at stage 76 prior to being prepared for storage or shipment at an end station 56.

The various sanding or polishing steps can be performed manually or automatically. In various examples, the sanding or polishing steps can be performed with adhesive paper or the like having various roughness amounts, such as between 100 grit and 400 grit, or more or less. It is understood that a relatively rougher sanding can be performed with 100 grit material, while a relatively finer sanding can be performed with 400 grit or greater material. Various other known polishers (e.g., adhesive paper, metal wool, polishing compounds, fabric polishing, etc.) can be used to provide super-fine polishing (e.g., 400-3200 grit or equivalent). For example, stage 76 can provide a final polishing of the outermost coating layer to reduce minor imperfections and/or even polish the entire layer to improve appearance. In one example, the sanding and/or polishing can be performed by an automatic or manual roll sander (not shown) that can apply generally equal sanding or polishing to the entire table top 12. In one example, the roll sander can work together with the movable conveyor to move the table top 12 relative to the roll sander, though other configurations are contemplated. The surface adjustment processes can also be performed in various other manners, including via chemicals, other abrasives (e.g., abrasive blasting, etc.) and the like.

As shown and described herein, some or all of the various steps can be performed manually, semi-automatically, or completely automatically by the use of a powered or un-powered conveyor system for moving the table top display 10 generally along the direction of arrow A. For example, one or more conveyors 38, 40, 41 can be placed in operative association such that a table top 12 can proceed first to the base-coat station (if provided), then to the printer, then to the sealant layer coater, and finally to the UV-cure oven. More or less steps, such as coating/cure steps, can be included. The entire process can be computer controlled, and/or any of the various steps can include human intervention.

The table top 12 can proceed through the various steps at various speeds. In one example, the table top 12 can proceed through the sealant layer coater at a speed of about 270 feet per minute, and through the UV-cure oven at a speed of about 15 feet per minute. Thus, the procession of the table tops 12 through the various steps can be manually or automatically staged to avoid collisions or the like. For example, the various conveyors 38, 40, 41 can be manually or automatically controlled to control the flow of the table top 12 through the various processes.

In addition or alternatively, the printing stage may be the most time-intensive portion step of the process. The use of a relatively large flat bed printer can provide an opportunity to print multiple tables at one time to increase efficiency. For example, where the printer has a maximum print length of about ten feet, three 36-inch tables or two 48-inch tables could be printed at the same time. Various patterns or arrays can occupy the printable area of the print station.

In addition or alternatively, one or more advertisements or other printed matter may include pictures, such as photographs, pre-printed matter or the like, and may be coupled to the upper surface 14 with any compatible adhesive. The pre-printed materials can be utilized together with the printed matter provided (e.g., printed) by the flat bed printer upon the table top 12.

In addition or alternatively, any or all of the processes discussed herein can be performed in a controlled environment to reduce, such as eliminate, problems caused by dust, debris, or the like. As can be appreciated, dust and debris can contaminate the printing and/or sealant layers. For example, at least one of the steps of printing the display and applying the sealant layer(s) can be performed in a room having a positive air pressure. In one example, the entire process can be performed in a generally sealed room 60, such as a clean room or the like. The sealed room 60 can have an air inlet 62 that can filter the incoming air. In addition or alternatively, the air inlet 62 can provide pressurized air such that the sealed room 60 has a positive pressure (e.g., greater than ambient pressure) to inhibit, such as prevent, dust, debris, or the like from entering the sealed room 60. The sealed room 60 can also include an air outlet 64, which may also filter the air and/or adjust the pressure within the room 60. It is understood that the sealed room 60 is adapted to generally maintain a positive pressure therein and may or may not be hermetically sealed, and may further be configured to permit various elements to enter and exit the room, such as air, people, table tops, equipment, etc.

Various advantages are provided. Because the ink is UV-curable, it dries very quickly upon printing. Moreover, because it is dried quickly, the table top can be coated using the curtain coater or the like in a relatively short time, such as nearly immediately, after printing. Further, because the sealant coating layer is also UV-curable, the coating can be cured relatively quickly as well. Thus, the total manufacture time of a printed table top display has been reduced from a conventional 2-3 days, down to mere hours (or less). As a result, a custom table can be available for same-day shipping to a customer.

Herein it is preferred that the electromagnetic radiation used to cure a radiation-cured composition or layer is ultraviolet radiation (“UV”). Alternatively, other wavelengths of electromagnetic radiation can be used based on selection of appropriate curing initiators, sometimes called photoinitiators, as is well understood in the art, for example radiation that is more or less energetic than ultraviolet radiation, typically X-rays, infrared light or visible light. In addition, the radiation can be provided in a variety of forms, e.g. it can be supplied from appropriately filtered incandescent bulbs, electron beam radiation, lamps that emit radiation incident to an electrical discharge, such as the well known mercury discharge lamps for generating “UV” radiation, etc. A radiation-cured material or composition is not necessarily intended to imply that the composition or material excludes (i.e. will not also be cured via) other modes of cure or cross-linking initiation, such as heat, chemical, electrical, or the like.

Ultraviolet radiation sources having an emission wavelength of about 180 nm to about 450 nm are preferred. Ultraviolet sources include, but are not limited to, sunlight, mercury lamps, arc lamps, zenon lamps, gallium lamps, or other types or even combinations thereof, etc. In one example, high-pressure mercury vapor discharge lamps can be used, which generate “UV” radiation incident to the mercury discharge, to cure the sealant layer. High-pressure lamps of this type generally having intensities of 30 W/cm to 400 W/cm may be used.

Conventional additives can be incorporated or added into the radiation-cured material to impart desired properties thereto. Such additives may include, e.g., polymeric or silicone coating surface improvers, flow improvers, dyes, pigments, flattening agents, anti-foaming agents, gas diffusers, light stabilizers and antioxidants, in varying amounts dependent upon desired function and performance of the final coating film. In one example, a gas diffuser additive can facilitate the release of gasses, such as air, from the sealant layer material to provide a relatively smoother flow coating and/or reduce the occurrence of bubbles or the like. Various example gas diffuser additives can include Gemini Defoamer or BYK-A500, or the like. Various other additives can be used to adapt a coating material for use in a curtain coater or a spray coater, etc.

In use, the table top advertising display is positioned in a restaurant for use by a restaurant customer. The customer brings a meal to the table and sits down to consume the meal. During the meal, the typical customer will actively peruse the advertising materials, thereby receiving a high level of advertising absorption. Food spills may be easily removed from the coating with a damp cloth, and such spills will not seep through to soil the protected advertisements underlying the coating.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A method of creating a display on a table top having an upper surface, comprising the steps of:
printing indicia on the upper surface of the table top using a radiation curable ink;
curing the printed indicia using a radiation source to create the display;
applying a first sealant layer over at least a portion of the display on the upper surface; and
curing the first sealant layer.

2. The method of claim 1, wherein the ink is an ultraviolet curable ink.

3. The method of claim 2, further comprising the step of exposing the printed ink to a source of ultraviolet light.

4. The method of claim 3, wherein the source of ultraviolet light comprises an electric lamp.

5. The method of claim 1, wherein the first sealant layer comprises a radiation curable material.

6. The method of claim 5, wherein the first sealant layer comprises an ultraviolet curable material, and the method further comprises the step of exposing the first sealant layer to a source of ultraviolet light.

7. The method of claim 1, wherein at least one of the steps of printing the indicia and applying the first sealant layer is performed in an environment having a positive air pressure.

8. The method of claim 1, further comprising the steps of applying a second sealant layer over at least a portion of the first sealant layer, and curing the second sealant layer.

9. The method of claim 8, wherein the second sealant layer comprises a radiation curable material.

10. The method of claim 1, further comprising the step of curtain coating the first sealant layer over at least a portion of the display on the upper surface.

11. The method of claim 10, further comprising the step of moving the table top at a controlled speed through a liquid curtain of the curtain coating to apply the first sealant layer.

12. The method of claim 1, further comprising the step of applying a surface adjustment process to the table top.

13. A method of creating a display on a table top having an upper surface, comprising the steps of:
printing indicia on the upper surface of the table top;
curing the printed indicia to create the display;
applying a first sealant layer using a radiation curable material over at least a portion of the display on the upper surface; and
curing the first sealant layer using a radiation source.

14. The method of claim 13, wherein the material of the first sealant layer is an ultraviolet curable material, and the method further comprises the step of exposing the material to a source of ultraviolet light.

15. The method of claim 13, wherein the ink is an ultraviolet curable ink, and the method further comprises the step of exposing the printed ink to a source of ultraviolet light.

16. The method of claim 13 further comprising the steps of applying a second sealant layer over at least a portion of the first sealant layer, and curing the second sealant layer.

17. The method of claim 13, further comprising the step of curtain coating the first sealant layer over at least a portion of the display on the upper surface by moving the table top at a controlled speed through a liquid curtain.

18. A method of creating a display on a table top having an upper surface, comprising the steps of:
printing indicia on the upper surface of the table top using a radiation curable ink;
curing the printed indicia using a first radiation source to create the display;
applying a first sealant layer using a radiation curable material over at least a portion of the display on the upper surface; and
curing the first sealant layer using a second radiation source.

19. The method of claim 18, wherein at least one of the first and second radiation sources comprises a source of ultraviolet light.

20. The method of claim 18, further comprising the step of curtain coating the first sealant layer over at least a portion of the display on the upper surface by moving the table top at a controlled speed through a liquid curtain.
